(19) United States
(12) Patent Application Publication
(10) Pub. No.: US 2013/0016041 A1
(43) Pub. Date: Jan. 17, 2013

(54) High Resolution Mouse

(71) Applicant: Kuo-Ching CHIANG, New Taipei City (TW)

(72) Inventor: Kuo-Ching CHIANG, New Taipei City (TW)

(21) Appl. No.: 13/211,337

(22) Filed: Aug. 17, 2011

Related U.S. Application Data
(63) Continuation-in-part of application No. 13/181,577, filed on Jul. 13, 2011.

(51) Int. Cl. G06F 3/033

(52) U.S. Cl. 345/166

(57) ABSTRACT

A high resolution mouse includes an illumination source, a sensor, lens is formed along optical path between the illumination source and the sensor; a resolution enhancing element is formed on the sensor and between a reflection surface of an object and the sensor to improve pitch resolution; wherein an index of reflection of the resolution enhancing element is greater than one; wherein the resolution enhancing element includes liquid, gas or solid material.

### CROSS-REFERENCE TO RELATED APPLICATION

This present application is a continuous in part of U.S. patent application Ser. No. 13/181,577, filed on Jul. 13, 2011, which is herein incorporated by reference.

### TECHNICAL FIELD

The present invention relates a mouse, and more particularly, a high resolution mouse.

### BACKGROUND OF THE RELATED ART

Recently, the consumer device, for instance, the digital still camera tablet, cellular toward the trend of thinner, lighter and multi-functions, the inside optical device also be minimization by the manufacture to achieve the demands. The manufacture not only costs down the cost but also shrinkages the size of the device, simultaneously. Recently, the density of the pixels of the image capture device in continuously increased. However, when the dimension of the lens is scaled down, some physical limitation is raised. The resolution of the CCD (Charge Coupled Device, CCD) or CMOS (Complementary Metal-Oxide Semiconductor, CMOS) sensor is improved by upgrading the manufacturing technology of these devices. Most of the mouse with red light source, and some introduce blue light source to improve resolution due to it has shorter wave length. But the cost is high.

### SUMMARY

A high resolution image capturing device comprises a lens; an image sensor; a resolution enhancing element formed on said image sensor and between said lens and said image sensor to improve resolution; wherein an index of reflection of said resolution enhancing element is greater than one. 2. The resolution enhancing element includes liquid or solid material which has said index of reflection greater than one of air. The high resolution image capturing device is integrated into a cellular, digital still camera or digital video camera. The liquid include water, liquid crystal or liquid solution and the liquid includes Cesium sulfate. The present invention provides a high resolution mouse including an illumination source; a sensor; and a resolution enhancing element is formed on the sensor and between a reflection surface of an object and the sensor to improve pitch resolution; wherein an index of reflection of the resolution enhancing element is greater than one.

### BRIEF DESCRIPTION OF THE DRAWINGS

FIG. 1-3 illustrate the image capturing device and lens set of the present invention.

FIG. 4 illustrate the mouse of the present invention.

FIG. 5-6 illustrates another embodiments of the present invention.

### DETAILED DESCRIPTION

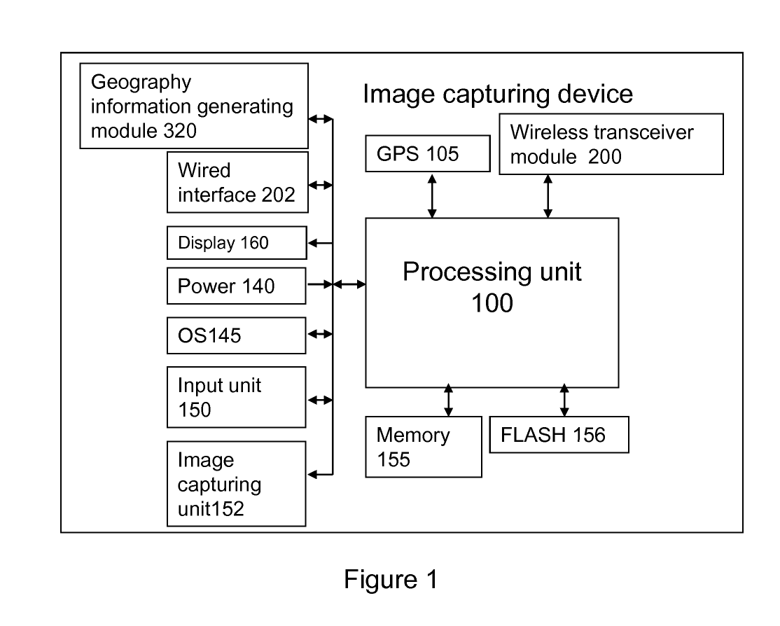

FIG. 1 and Figure disclose the high resolution image capturing device. The present invention includes a processing unit 100, an optional GPS 105 coupled to the processing unit 100. An image capturing module 152 is coupled to the processing unit 100 to capture image. A display 160 is coupled to the processing unit 100 to display the captured image. The captured image may include geography information fetched by the GPS 105 merged thereon. A geography information generating module 320 is introduced and coupled to the processing unit 100 to receive the data fetched from the GPS 105 and integrates the GPS data into the captured image. Memory 155 and FLASH 156 are used to store the image or data. A wireless transceiver module 200 such as WiFi [symbol] WiMax [symbol] 3G [symbol] 3.5G or 4G is coupled to the processing unit 100 to transmitting and receiving data.

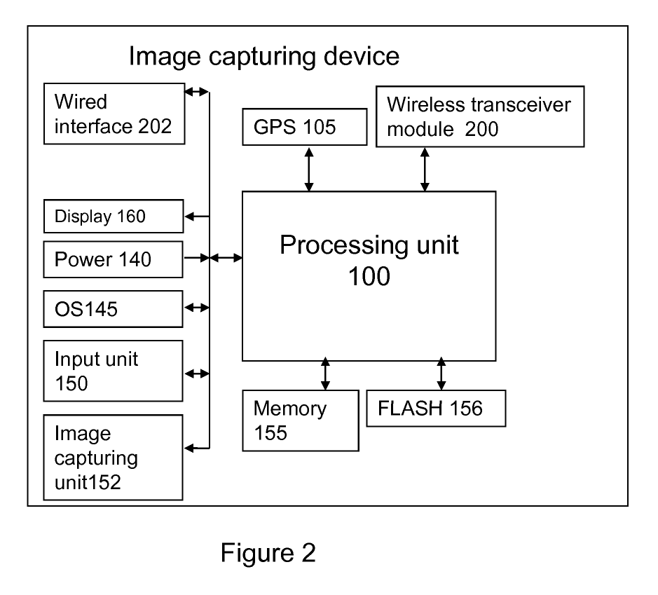

Please refer to FIG. 2, most of the elements is similar to the FIG. 1 but the geography information generating module 320 is located in a remote terminal. The user may uses the wireless transceiver module 200 such as WiFi [symbol] WiMax [symbol] 3G [symbol] 3.5G or 4G to transmit the captured image and GPS information to the remote terminal to merge the image and GPS data. If the resource of the memory and computing is insufficiency, the user may couple to the remote terminal to inquire upgraded resource to computing the demand instruction. The USB 202, FLASH 156 and the processing unit 100 construct a flash drive for editing, reading, programming and erasing.

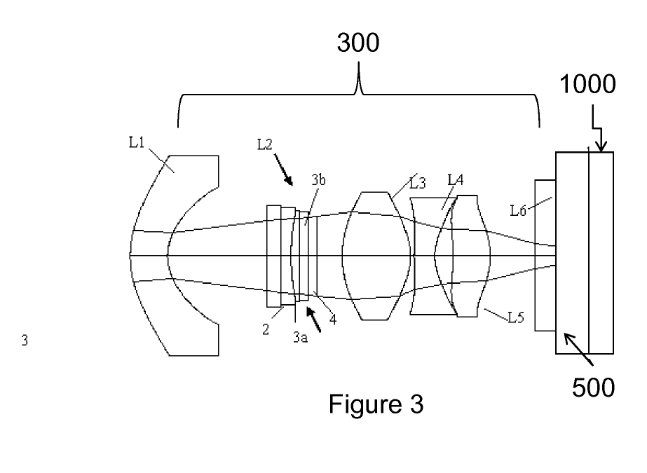

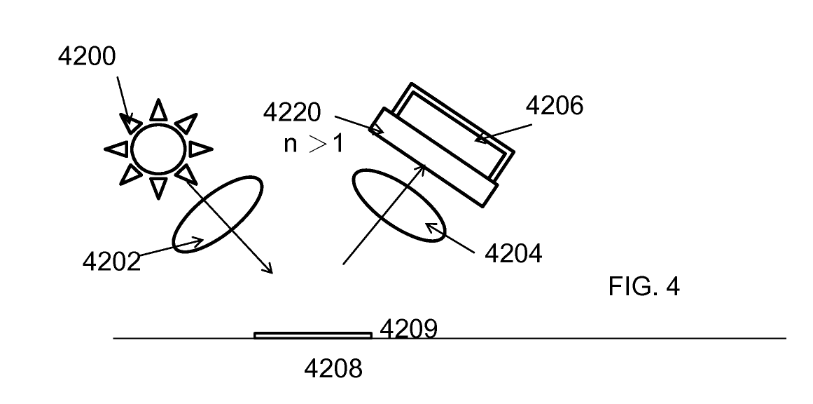

The image capturing device includes Lens set 300 configuration as shown in FIG. 3. The Lens set 200 from the object side along to the optical axis to the image side includes a first lens L1, a second lens L2, a third lens L3, a forth lens L4 and a fifth lens L5. A planar lens L6 with infinite focus is set behind the fifth lens L5. The planar lens L6 may be a IR filter, OLPF or protection glass. The arrangement of the Lens set may be changed by demand.

The first lens L1 has negative diopter and the convex surface towards the object side. The second lens L2 may be a focal electrical-changeable device and is capable to adjust the focal length. The third lens L1 has positive diopter and the both sides of the lens are convex surfaces that toward the object side and image side, respectively. The forth lens L4 has negative diopter and the concave surface towards the image side while the fifth lens L5 has positive diopter and the convex surface towards the image side.

The second Lens from the object side to the image side along the optical axis includes a first cover lens 2, focal changeable lens 3 and a second cover 4. The first cover lens 2 and the second cover 4 seal both sides of the focal changeable lens 3 which is composed by a fist material 3a and a second material 3b. The curvature of the fist material 3a and a second material 3b may be changed by applying electricity energy on the materials to change the focal length. The focal changeable lens 3 may be a liquid lens which is filled with liquid, liquid crystal, immersion material. When the electrical bias is supplied, the index of refraction of the material is change, thereby changing the focal length. The first lens L1, the second lens L2, the forth Lens L4 and the fifth lens L5 may be formed by plastic, glass, resin, quartz.

The present invention includes a resolution enhancing element 500 formed between the Lens set 300 and the image sensor 1000. The pitch resolution is determined by the illumination wave length and the numerical aperture. The relation is determined by Rayleigh formula. R=k1λ/NA; wherein the R indicates the resolution, λ is wave length; where NA is the numerical aperture and k1 is a constant. Typically, the resolution may be improved by upgrading numerical aperture the optical system. Thus, the bigger the lens is, the higher the resolution. The definition of DOF (depth of focus) is a lens optics concept that measures the tolerance of placement of the image plane (the film plane in a camera) in relation to the lens.

DOF=k2 λ/(NA)²; R=k 1 λ/NA . Therefore, there is limitation to adjust the numerical aperture. If the wave length of the light in the air is λ and the index of refraction of an media is n; while the wave length of the light in the media is λ′=λ/n and typically, the index of refraction is 1; if the n is larger than 1, then the λ′=λ/n is shorter than the wave length in the air. Namely, the wave length of the light is shorten in the media, thereby improving the resolution. Thus, the present invention may improve the resolution under the identical numerical aperture.

The resolution enhancing element 500 attached between the Lens set 300 and the image sensor 1000 may improve the resolution. For example, liquid, solid martial is formed or coated over the image sensor may change the wave length in the resolution enhancing element 500 to shorten the wave length to improve the resolution. The liquid may be water, liquid crystal, the solid material may be oxide, glass, resin, quartz. In the case of water, the index of refraction of water is 1.44 and the air is 1. The index of refraction ratio between air/water is 1/1.44. The resolution will be improved. The pure water may eliminate the generation of bubble in the liquid. The additive material such as Cesium sulfate may raise the water index of refraction to 1.6. The uniform solid material may be used such as sapphire may be used to replace the liquid media. Glass, quartz, plastic, liquid crystal, pebble or acrylic may be utilized. The means may be used for the portable device with digital still camera or video camera.

The above embodiment can be introduced into a pointing device such as mouse for a computer. Please refer to figure. The mouse includes a housing to receive the light source 4200, sensor 4206, lens 4202, 4204. The light source illuminates light onto the surface 4208 of an object such as desk, and the sensor 4206 detects the reflected light through the lens 4202, 4204 from the desk, and the circuits transmits the signal to the computer to indicate the position of the cursor.

A resolution enhancing element or wave-length altering element 4220 is attached between the lens 4204 and the sensor 4206; or attached on the sensor 4206. The pitch resolution is dependent on the wave length and the numerical aperture, the shorter the wave length, the higher the pitch resolution. It is expressed by the Rayleigh formula: Pitch resolution, R=k1 λ/NA, λ is wave length; NA is the numerical aperture. The short wave length may get small pitch pattern image, which has higher resolution. If the light wave length is λ in air and the wave length of the same illumination is λ′=λ/n in the media which has index of refraction n; if n is greater than 1, thus, the λ′ is shorten, thereby improving the pitch resolution. The resolution enhancing element or wave-length altering element 4220 can be set or arranged between the lens 4204 and the sensor 4206 to replace the air to improve the resolution. The resolution enhancing element or wave-length altering element 4220 can be solid, liquid, gas with index of refraction which is greater than 1.

In another example, water, liquid or solution is encapsulated between the lens 4204 and the sensor 4206. The index of refraction: the air (1)<water (1.44), the wave length in the water is 1/1.44 to the one in the air. The bubble should be removed from the water. If Cesium sulfate is added in the water, the index will be raised to 1.6. The other uniform solid material could be used, for instance, glass, quartz, crystal, resin, plastic, Acrylic, polymer or the like. For example, if the incident light wave length is 850 nm, the 590 nm pitch resolution can be obtained; 326 nm resolution can be obtained if 470 nm incident light wave length is employed. If incident light wave length of 677 nm is used, 470 nm resolution is obtained. Namely, the blue light resolution can be achieved by introducing yellow light as the illumination. Similarly, if the blue ray resolution is acquired by using the red light illumination, the material with index of reflection 1.8 is desired.

r≈iπd[(n²−1)/λ]exp[(iπd[(n²+1)/λ)]

wherein indicates the amplitude of reflect light; d is the thickness of the material; λ indicates the wave length.

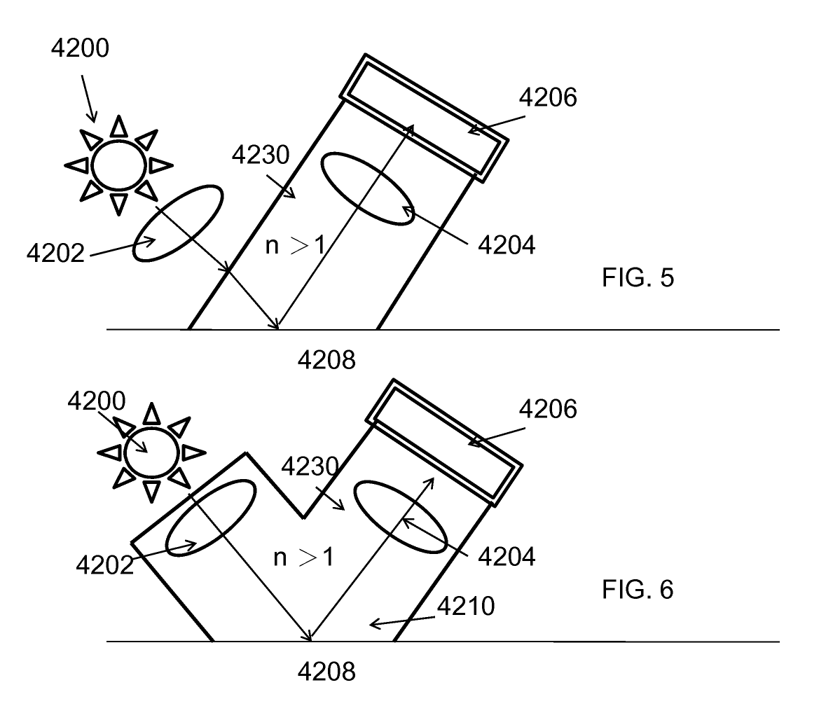

In general, the amplitude of reflect light is proportion to 1/λ, and proportion to the polarization coefficient of the material: (n²−1). If the reflected surface material is paper or sheet, the intensity of the reflection light from the surface is about 1/λ². If the thin material 4209 of wave-length altering element 4220 is arranged on the reflection surface, the intensity of the reflection light from the object surface may be raised. The intensity comparison between the wavelength 470 nm and 850 nm is about (850)²/(470)²=3.3. FIGS. 5-6 show the other embodiment with wave-length altering element 4220 set, partially, along the optical path from illumination source 4200 to the sensor 4220. Apparently, the present invention may obtain the higher resolution by using longer wavelength illumination source. Namely, the present invention may obtain the pitch resolution beyond 850 nm light source if the wavelength of the illumination source is 850 nm.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A high resolution mouse, comprising:
an illumination source;
a sensor; and
a resolution enhancing element formed on said sensor and between a reflection surface of an object and said sensor to improve pitch resolution; wherein an index of reflection of said resolution enhancing element is greater than one.

2. The mouse of claim 1, wherein said resolution enhancing element includes liquid, gas or solid material which has said index of reflection greater than one of air.

3. The mouse of claim 2, wherein said liquid include water or liquid solution.

4. The mouse of claim 3, wherein said liquid includes Cesium sulfate.

5. The mouse of claim 2, wherein solid material includes glass, quartz, plastic, liquid crystal, pebble, polymer or acrylic.

6. A high resolution mouse, comprising:
an illumination source;
a sensor;
lens formed along optical path between said illumination source and said sensor;
a resolution enhancing element formed on said sensor and between a reflection surface of an object and said sensor to improve pitch resolution; wherein an index of reflection of said resolution enhancing element is greater than one; wherein said resolution enhancing element includes liquid, gas or solid material.

7. The mouse of claim 6, wherein said liquid include water or liquid solution.

8. The mouse of claim 7, wherein said liquid includes Cesium sulfate.

9. The mouse of claim 6, wherein solid material includes glass, quartz, plastic, liquid crystal, pebble, polymer or acrylic.

10. A high resolution mouse, comprising:
an illumination source;
a sensor;
wavelength changing element formed on said sensor and between a reflection surface of an object and said sensor to shorten a wavelength of said illumination source;
wherein said wavelength changing element includes liquid, gas or solid material which has an index of reflection greater than one.

11. The mouse of claim 10, wherein said liquid include water or liquid solution.

12. The mouse of claim 11, wherein said liquid includes Cesium sulfate.

13. The mouse of claim 10, wherein solid material includes glass, quartz, plastic, liquid crystal, pebble, polymer or acrylic.
